(19) United States
(12) Patent Application Publication
(10) Pub. No.: US 2023/0198786 A1
(43) Pub. Date: Jun. 22, 2023

(54) COMPUTER-IMPLEMENTED SYSTEMS AND METHODS FOR EFFICIENT AND SECURE PROCESSING, ACCESS AND TRANSMISSION OF DATA VIA A BLOCKCHAIN

(71) Applicant: nChain Licensing AG, Zug (CH)

(72) Inventors: Craig Steven WRIGHT, London (GB); Jack DAVIES, London (GB)

(21) Appl. No.: 17/924,961

(22) PCT Filed: Apr. 23, 2021
(86) PCT No.: PCT/IB2021/053379

§ 371 Date: Nov. 11, 2022

(30) Foreign Application Priority Data
May 15, 2020 (GB) 2007238.5

(51) Int. Cl. H04L 9/00; H04L 9/30

(52) U.S. Cl. CPC H04L 9/50; H04L 9/30

(57) ABSTRACT

Methods and systems are provided for storing, sharing, retrieving, writing and accessing data (content) on a blockchain such as, for example, the Bitcoin ledger. Embodiments of the method may comprise the step of processing at least one blockchain transaction (Tx) comprising: a protocol flag; at least one discretionary public key (DPK); and at least one discretionary transaction ID (DTxID). These are discretionary in the sense that they are not required as part of the underlying blockchain protocol but in accordance with present disclosure. The at least one transaction (Tx) also comprises a plurality of inputs, each input having: i) a parent public key (PPK) and ii) a signature (S) generated using the parent public key (PPK). Thus, the transaction forms an indexed node in a graph or hierarchical tree of logically associated nodes at least some of which include or reference portions of data. The nodes in such a tree can have multiple parents and/or children. Authorised access to the data is cryptographically enforced. Large, complex data sets can be represented, stored, communicated and identified in a secure and efficient manner over a resilient, peer-to-peer architecture.

### CROSS REFERENCE TO RELATED APPLICATIONS

This application is the U.S. National Stage of International Application No. PCT/IB2021/053379 filed on Apr. 23, 2021, which claims the benefit of United Kingdom Patent Application No. 2007238.5, filed on May 15, 2020, the contents of which are incorporated herein by reference in their entireties.

Embodiments of the present disclosure relate generally to improvements for secure data transfer across an electronic network, and in particular a peer-to-peer network. It relates to data storage, access, retrieval, processing and transmission, and more particularly to such data-related activities on a blockchain network. Embodiments are particularly suited, but not limited to, use in processing and sharing data between entities using the blockchain as an underlying mechanism or platform to eliminate or at least alleviate disadvantages associated with traditional server-based architecture. Thus, embodiments of the disclosure provide a secure, resilient, efficient, cryptographically-enforced, alternative network infrastructure for data processing, storage, access control, versioning and transfer.

### BACKGROUND

A “blockchain” refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks up until one or more coinbase transactions. Coinbase transactions are discussed below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at a node, and the publication of blocks can be achieved through the publication of mere block headers.

The transactions in the blockchain are used to perform one or more of the following: to convey a digital asset (i.e. a number of digital tokens), to order a set of journal entries in a virtualised ledger or registry, to receive and process timestamp entries, and/or to time-order index pointers. A blockchain can also be exploited in order to layer additional functionality on top of the blockchain. Blockchain protocols may allow for storage of additional user data or indexes to data in a transaction. There is no pre-specified limit to the maximum data capacity that can be stored within a single transaction, and therefore increasingly more complex data can be incorporated. For instance, this may be used to store an electronic document in the blockchain, or audio or video data.

Nodes of the blockchain network (which are often referred to as “miners”) perform a distributed transaction registration and verification process, which will be described in detail below. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node that successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

As explained above, additional layers of functionality can be used on top of the blockchain. Moreover, Blockchain protocols may allow for storage of additional user data, or indexes to data, in a transaction. Today, data communication is commonly achieved via the use of systems that provide the data over the Internet, with servers hosting web sites and pages which users visit in order to access the desired data, typically with a search engine. However, use of the internet as a repository for storing and sharing data does not come without challenges. These include concerns regarding how to effectively and securely control data, and how to enable efficient storage, search and exchange of that data with authorised third parties. Although the internet uses a decentralised architecture, in practice it enables centralised organisations and businesses to control and monetise large amounts of data and content, often without the consent or even knowledge of the party that created that data or to whom it relates. Internet-related functionality and tools such as search engines, Email services, file and web hosting etc. are often dominated if not effectively controlled by large corporations and bodies which use their own computing resources e.g. servers for those purposes. If these servers fail, or are compromised by security hacks or DDoS attacks, then vital services are interrupted, or data security and privacy are breached. Some have questioned whether these organisations have become “too big to fail”, with too much power and vested interest to be trusted to run an essential, global network such as the Internet. The client-server approach and centralised implementation of the internet gives rise to serious technical concerns relating to scalability, security, privacy, data ownership and data mining exploitation. In effect, it is vulnerable to trusted entities.

These concerns have lead some observers to start exploring the use of the blockchain to address at least some of these disadvantages relating to the Internet. See, for example, “Life After Google: The Fall of Big Data and the Rise of the Blockchain Economy”, George Gilder, Gateway Editions, July 2018, ISBN-10: 9781621575764 and ISBN-13: 978-1621575764. Therefore, a decentralised and distributed, resilient and scalable alternative is desired.

Various aspects of a blockchain-implemented solution known as “the Metanet” are presented in International patent applications PCT/IB2019/059807, PCT/IB2019/059808, PCT/IB2019/059809, PCT/IB2019/059793, PCT/IB2019/059795, PCT/IB2019/059791, PCT/IB2019/059803 and PCT/IB2019/060226, all of which are incorporated herein in their entirety.

The Metanet is a transaction-based protocol for structuring an on-chain realisation of a large scale network for indexing, linking, permissioning, sharing and storing data, such as the Internet. A core aspect of the protocol is that is ensures that internet-like data mined into a blockchain is included in a specific transaction format, such that a directed acyclic graph (DAG) of this data can be interpreted off-chain by any user. The Metanet DAG comprises nodes (blockchain transactions) and edges (created by cryptographic signatures) connecting these nodes.

The design goals of the Metanet include the need for an adequate degree of simplicity and generality, whilst also ensuring that the graphs created in accordance with the protocol do not contain any cycles, which is a known requirement for any DAG as cycles can give rise to various technical challenges such as security or authorisation failures in hierarchical systems built on DAG structures. In order to achieve these technical goals, the nodes of a Metanet DAG can have either zero or one parent only (an ‘in-degree’ of zero or one). By contrast, no such restriction is placed on the number of children any node may have (an ‘out-degree’ that is free). While the restriction placed on the in-degree of a node is suitable for many applications and use cases, there may also be situations where it is desirable for a given node to have more than one parent. For instance, if implementing a GIT-like versioning structure, or efficiently and accurately representing the data structure of an amalgamation of two entities on-chain.

### SUMMARY

One or more embodiments of the present disclosure provide an alternative, improved data mechanism for secure and efficient storage, sharing, structuring, permissioning, versioning, indexing, addressing, accessing and/or searching of data. Embodiments provide improvements that at least allow for a node in a (Metanet-type) hierarchy of nodes to have multiple parents, without eroding the security and other benefits that flow from the Metanet protocol. Thus, embodiments of the disclosure ensure that multi-parent nodes, to be referred to as ‘Metanet confluences’ for ease of reference, can be created without introducing cycles to a Metanet DAG, which could give rise to technical problems including compromised security and authorisation issues.

Embodiments also provide, among others, the advantage of being able to store, share and access data structured on top of a blockchain in a more versatile and complex structure than previously known in the art, thus leading to improved efficiency for access, retrieval and transmission of the data due to its wider applicability in respect of the applications that use that data and the organisations/entities that utilise, generate and/or control it. This improved technical versatility and wider applicability enables the implementation of more complex and advantageous data applications using blockchain networks as the underlying infrastructure and security mechanism.

The principle allowing for the creation of Metanet confluences is that the requirement of ‘0 or 1 parent per node’ is replaced with ‘0 or 1 parent per input’. This divergence from the known art represents a number of technical challenges, not least because the blockchain transactions and the applications and systems which implement and utilise the resulting data structure/network (e.g. digital wallets and data-oriented blockchain applications) have to be reformulated and re-designed. Embodiments require alterations to the cryptographic operations that are performed, for example, in creating the new data structures and subsequent verification of cryptographic controls such as digital signatures. Solutions to at least these challenges are provided by embodiments of the disclosure, which are described below.

### BRIEF DESCRIPTION OF THE DRAWINGS

Aspects and embodiments of the present disclosure will now be described, by way of example only, and with reference to the accompany drawings, in which:

FIG. 1 shows an example system for implementing a blockchain for use in accordance with embodiments of the present disclosure.

FIG. 2 illustrates an example of UTXO-based transaction protocol, which may be used in conjunction with the system shown in FIG. 1.

FIG. 3A illustrates a possible implementation of a client application for use in accordance with one or more of the presently disclosed embodiments.

FIG. 3B illustrates a user interface (UI) that may be used in accordance with one or more of the presently disclosed embodiments.

FIG. 4 illustrates an example of node software that can be run on each blockchain node of a network in accordance with one or more of the presently disclosed embodiments.

FIG. 5 shows a schematic illustration of a simple Metanet structure comprising a confluence node with two parents, in accordance with an illustrative embodiment of the present disclosure.

FIG. 6 shows a Metanet tree (DAG) comprising transactions as nodes and signatures as edges.

FIG. 7 shows an illustrative embodiment in which a confluence node is formed by the convergence of two distinct Metanet trees.

### A SUMMARY OF THE METANET PROTOCOL AND DAG STRUCTURE

Various aspects of the Metanet protocol and some possible implementations are provided in detail in PCT/IB2019/059807, PCT/IB2019/059808, PCT/IB2019/059809, PCT/IB2019/059793, PCT/IB2019/059795, PCT/IB2019/059791, PCT/IB2019/059803 and PCT/IB2019/060226. However, for the sake of convenience and ease of reference, a brief overview of the Metanet protocol and its principles are provided here.

It is known in the art that in addition to being used for the transfer of digital assets, blockchain transactions (TXs) can be used to store and communicate data. This can be any kind of data, include digital media content of any description, text, software or code, images etc. The term “data” in this document is not intended to be limited with respect to its type, format, purpose or nature.

The Metanet comprises a “tier-2” protocol that does not require modification of the protocol or consensus rules associated with the underlying blockchain, yet provides a mechanism whereby transactions (which may be referred to as “nodes”) can be structured in logical, hierarchical way that allows for addressing of nodes, permissions, and content (i.e. data) version control.

The aims and effects of a Metanet-implemented structure include but are not limited to being able to:
(i) Associate related content in different transactions (TXs) to enable efficient and secure searching, identification and access
(ii) Allow identification of content using human-readable keyword searches, to improve speed, accuracy and efficiency of searching and retrieval
(iii) Build and emulate server-like structures within a blockchain without the need for a centralised architecture; this alternative architecture not only addresses challenges relating to ownership and control of data by centralised parties but introduces network resilience, availability and distributed processing that is not otherwise possible with traditional approaches
(iv) Leverage and utilise the immutable timestamping and event-ordering advantages of blockchain technologies; conventional Internet-based implementations do not comprise such mechanisms and therefore are not able to provide solutions that are as flexible or powerful in their functionality;
(v) Ability to use blockchain-implemented micropayment channels and such mechanisms for a more granular and nuanced control over when and how access is granted; this results in permissioning, privacy, control and monetisation options that are not possible with conventional internet-based systems

The Metanet approach is to structure data provided within transactions as a directed graph (DAG). The nodes and edges of this graph correspond to:
Node—A transaction associated with the Metanet protocol. A node stores content. (The terms “content” and “data” may be used interchangeably within this document).
A node is created by including an OP_RETURN in a script. In Bitcoin, OP_RETURN is a script opcode that marks a transaction output as invalid. Note: the skilled person will readily appreciate that embodiments can be devised which do not use OP_RETURN. Embodiments which utilise a non-Bitcoin protocol may comprise a functionally equivalent or similar mechanism as an alternative, while still falling within the scope of the present disclosure.
The OP_RETURN is immediately followed by <Metanet Flag>. This indicates that the transaction is arranged in accordance with, and for use with, the Metanet protocol.
Each node is assigned a public key P_{node}. The combination of this public key and a discretionary Metanet transaction ID uniquely specify the index of the node:

ID_{node}:=H(P_{node}∥TxID_{node})
The Metanet transaction/node ID can be referred to as “discretionary” in order to distinguish it as a transaction identifier that is not part of or specified by the underlying blockchain protocol.
The hash function (H) should be consistent with the underlying blockchain protocol that the embodiment is to be used with e.g. SHA-256 or RIPEMD-160 for Bitcoin.
Edge—An association of a child node with a parent node.
An edge is a logical link created when a signature Sig Pₚₐᵣₑₙₜ appears in the input of a Metanet transaction, and therefore only a parent can give permission to create an edge. In previous Metanet disclosures, all nodes are defined as having at most one parent, although a parent node may have an arbitrary number of children. In the language of graph theory, the indegree of each node is at most 1, and the outdegree of each node is arbitrary.
However, while such a limitation is helpful for a wide variety of applications and there is often a desire or need for simplicity of structure and/or implementation, such an approach is restrictive or even disadvantageous with regard to use cases and applications which necessitate a more complex representation. In such situations, it would not be possible to reflect the required structure of the system in an accurate or sufficiently complex way. The restricted model would, in those cases, lead to flawed or inefficient system designs, or even render a solution as infeasible. Some examples of such applications are provided below.
It should be noted that an edge is an aspect of the Metanet protocol and is not itself a transaction associated with the underlying blockchain.

A valid Metanet node (with parent) is given by a transaction of the following form:

TABLE 1
TxID_{node}

| Input | Output |
|---|---|
| <Sig Pₚₐᵣₑₙₜ> <Pₚₐᵣₑₙₜ> | OP_RETURN <Metanet Flag> <P_{node}> |
| | <TxIDₚₐᵣₑₙₜ> |

Note here that the first OP_RETURN element is always the 4-byte prefix ‘0x4d455441’, which is simply the hexadecimal form of the Metanet flag ‘META’.

However, the simplest form of Metanet node (called a “root” node) is one which does not have a parent and can be represented in a blockchain transaction (Tx) as follows, with a null element instead of a discretionary Transaction ID of a parent:

TABLE 2
TxID_{node}

| Inputs | Outputs |
|---|---|
| <Sig P_{any}> <P_{any}> | OP_RETURN <0x4d455441> <P_{node}> <Null> |

Thus, a Metanet transaction is a blockchain transaction arranged in accordance with the Metanet protocol such that it contains all the information needed to specify the index of the node and its parent

ID_{node}=H(P_{node}∥TxID_{node}), IDₚₐᵣₑₙₜ=H(Pₚₐᵣₑₙₜ∥TxIDₚₐᵣₑₙₜ).

Moreover, since the signature of the parent node is required, only a parent can create an edge to a child. If the <TxIDₚₐᵣₑₙₜ> field is not present, or it does not point to a valid Metanet transaction, then the node is an orphan. It has no higher-level node by which it can be reached. Additional attributes may be added to each node. These may include flags, names and keywords.

As shown, the index of a node (transaction) can be broken down into
a) Public Key P_{node}, which is interpreted as the address of the node
b) Transaction ID TxID_{node}, which is interpreted as the version of the node

Two advantageous features arise from this structuring:
1. Version control—If there are two nodes with the same public key, then we interpret the node with transaction ID with greatest proof of work as the latest version of that node. If the nodes are in different blocks, then this can be checked with the block height. For transactions in the same block, this is determined by the Topological Transaction Ordering Rule (TTOR).
2. Permissioning—A child of a node can only be created if the owner of the public key P_{node} signs the transaction input in the creation of a child node. Therefore P_{node} not only represents the address of a node but also the permission to create a child node. This is intentionally analogous to a standard Bitcoin transaction—a public key in not only an address but also the permission associated with that address.
   Note that since the signature of the parent node appears in a UXTO unlocking script it is validated through the standard miner validation process at the point when the transaction is accepted to the network. This means that the permission to create a child node is validated by the Bitcoin network itself.

It is worth noting that standard Internet Protocol (IP) addresses are unique only within a network at a certain point in time. On the other hand, the index of a node in the Metanet is unique for all time and there is no notion of separate networks, which allows data to be permanently anchored to a single object ID_{node}.

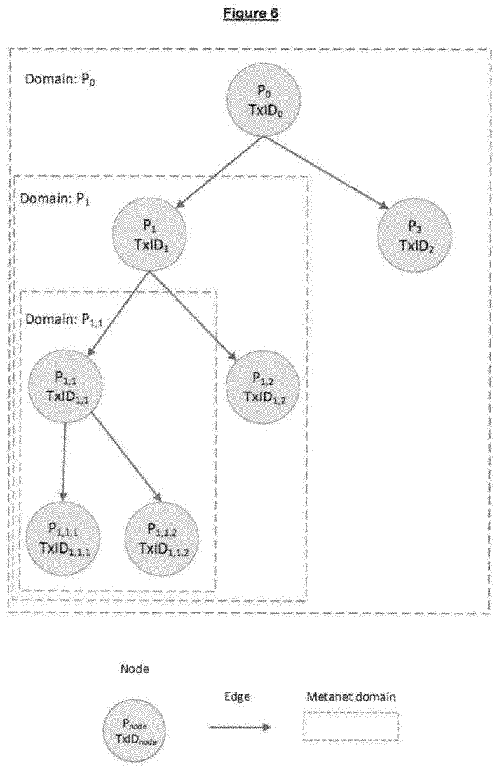

This node and edge structure allows us to visualise the Metanet as a graph, as shown in FIG. 6 which depicts an illustrative Metanet tree (DAG) comprising transactions as nodes and signatures as edges.

Thus, the rules for the DAG structure used in the Metanet can be summarised as follows:
1. The nodes of the DAG are blockchain transactions;
2. The edges of the DAG are digital signatures;
3. Each node has a unique identifier ID_{node} generated from a public key P_{node} combined with its transaction identifier TxID_{node}.
   (note, this Metanet node/transaction ID is an additional identifier which is distinct from the transaction ID (TxID) that the underlying blockchain protocol requires; in order to distinguish between the two forms of transaction ID we refer herein to the one used in accordance with the Metanet protocol as “discretionary” because it is not a requirement of the blockchain protocol itself)
4. The node public key P_{node} defines the requirement of a signature Sig P_{node} to create a Metanet-valid child of that node.
5. Anode may have in-degree of 0 or 1 and any out-degree (i.e. a free parameter).

In the case where a node has a parent, the public key signing its input must be that of its parent, denoted by Pₚₐᵣₑₙₜ, because the parent key defines the permission requirement to create a child. In the case of a root node (which has no parent) this signing key P_{any} can be any public key, and there is no such requirement on it.

However, in both cases we can see that rule 5 is in use, as there is either one parent signing key (Table 1) or no parent signing key (Table 2), and thus either transaction is only deemed to have one or zero parents respectively. The transactions shown in these tables are the simplest form of Metanet-valid transactions. From these, though, we can create more complex transactions that include many inputs and outputs, content/data and schemas built on top of this basic framework. Metanet DAG structures and can be created by constructing transactions using these simple rules.

### Illustrative Embodiments of the Present Disclosure

For the purposes of illustration, we now provide a description of one or more embodiments of the present disclosure. These provide, at least: efficient and secure techniques for storing, processing, searching, transferring and/or retrieving data on, from or via an electronic peer-to-peer network such as a blockchain. One or more embodiments also provide, at least: an alternative, blockchain-implemented network infrastructure for storing, processing, retrieving, transferring, searching, identifying and/or sharing data between computing nodes. By extending the functionality of the blockchain network in a new, technical way, one or more embodiments of the disclosure provide security and control of access to digital resources over an alternative, improved computing platform comprising a blockchain and an associated blockchain protocol which is implemented using computing nodes. Improved control and security is achieved, along with enhanced network resilience, decentralisation and security.

Moreover, embodiments enable the creation and use of more complex data structures which are associated, secured and addressed/indexed via cryptographic mechanisms. Therefore, embodiments enable a more efficient means of locating, identifying and accessing associated data items which are dispersed over a global, de-centralised, peer-to-peer storage platform (the ledger). This is a significant technical challenge, not least because the associated data items may be stored at any location (i.e. transaction) within the ledger and therefore it is crucial that they are structured in a way which allows efficient access, both in terms of time and processing resources. Embodiments also ensure that operations performed in relation to the stored data are performed only by authorised parties, thus preserving the integrity and security of the data within the system.

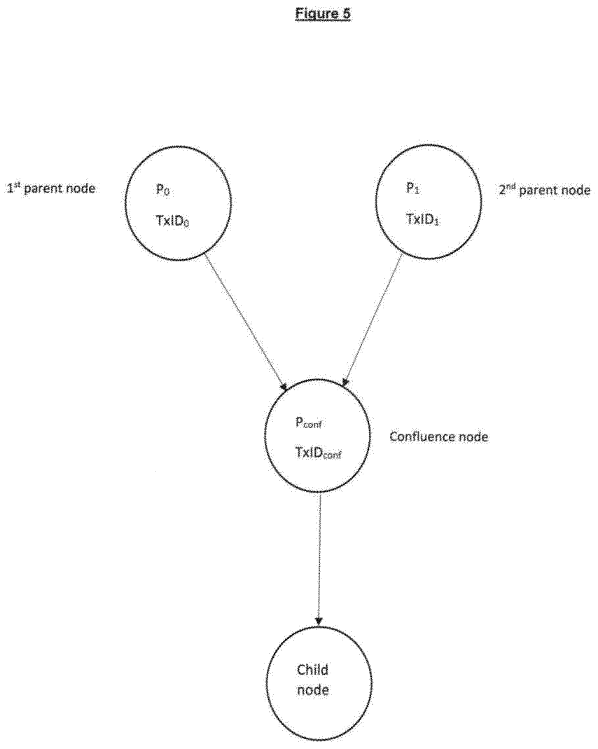

One or more embodiments of the present disclosure implement the concept of a ‘Metanet confluence’. This provides for the creation of Metanet nodes with more than one parent, as depicted in FIG. 5. A Metanet confluence (or ‘confluence node’) is a class of node whose technical properties and functionalities differ from the classes of nodes defined in the original Metanet protocol summarised above.

A Metanet confluence is a node i.e. a position in a graph, where multiple, previously unconnected Metanet trees or branches (graphs) converge. In order to create such a node, input signatures are required from two parents—one from each of the multiple convergent trees or branches. This also means that a Metanet confluence transaction is by definition a node with more than one parent, which violates one of the rules—the parent paradigm—as specified in the original Metanet protocol summarised above. Thus, the present disclosure is a significant deviation from the original protocol in that it teaches against previous Metanet teachings.

The Parent Paradigm

As explained above, one of the rules established in the original Metanet protocol was the parent paradigm, which states that:
“A node may have 0 or 1 parent”

This rule allowed the definition and distinction of a total of two classes of node, root nodes (nodes which have no parent) and non-root nodes (nodes which have exactly one parent) as per Tables 1 and 2. In this framework, there is no such notion of a class of nodes with a number of parents other than 0 or 1.

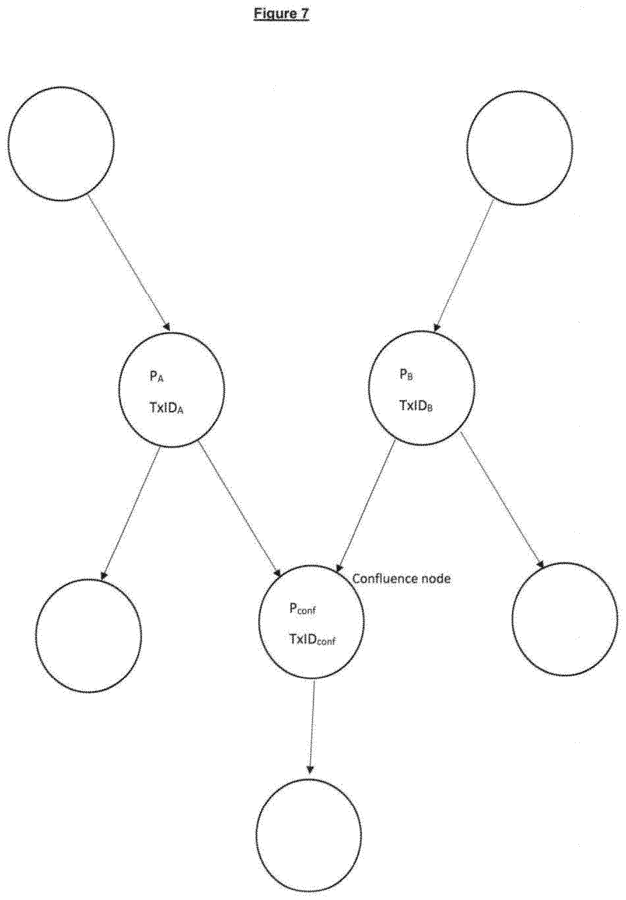

With reference to FIGS. 5 and 7, a confluence node is a new class of node which can have any number of parents k in the range of values 2≤k≤n, where n is the number of inputs of the confluence node transaction.

In order to accommodate the class of confluence nodes, the parent paradigm protocol rule is replaced with:
“A node may have 0 or 1 parent per input”.

This alteration of the parent paradigm now accounts for all three classes of nodes in a simple and succinct fashion, which is summarised in Table 3 below. The ‘minimum’ number of inputs of a node is the minimum number of inputs required for the node to accommodate all of its parents.

TABLE 3
A summary of the node classes accounted for
under the reformulated parent paradigm.

| | | Minimum no. | No. parents |
|---|---|---|---|
| Node class | No. parents | inputs | per input |
| Root | 0 | 1 | 0 |
| Non-root | 1 | 1 | 1 |
| Confluence | 2 ≤ k ≤ n | k | 1 |

It should be noted here that, when referring to the inputs of a node, we are in fact referring to the ‘Metanet-related’ inputs of that node. For example, it is possible to have a simple, non-root node which has many inputs but only one that is signed by parent key in accordance with the present disclosure. The other inputs can be completely unrelated to the Metanet protocol and used, for example, to fund the transaction or specify a payment in addition to the creation of the node.

Importantly, the Metanet protocol is always agnostic to such additional inputs, and only takes into account the Metanet-related inputs. This principle also applies to confluence transaction nodes in the same way. It is possible for a confluence node to have as many as n inputs, where only a subset of k of these inputs are Metanet-related. This means that the confluence node has k≤n parents, because the Metanet protocol only considers the k inputs that are Metanet-related.

It should be noted that there are three scenarios whereby a Metanet confluence can be used. The first is whereby a confluence causes multiple, distinct trees to converge; the second whereby a confluence causes multiple branches within a tree to converge and the third as some combination of the other scenarios.

Confluence Transaction Structure

The structure of a Metanet confluence transaction is similar to that of a non-root transaction, with two key differences:
1. A confluence transaction includes a distinct input for each parent. Each input comprises a signature Sig P_{parent,i} and public key address P_{parent,i} in its unlocking script, corresponding to the permission of an i^{th} parent to make a child.
2. A confluence transaction includes a reference TxID_{parent,i} for each of its parents. In one or more embodiments, these references begin at the third element in the OP_RETURN output of the confluence transaction.

These two aspects of a confluence transaction are deviations of the Metanet transaction format for creating simple root and non-root transactions, updated here to accommodate multiple parents.

This allows a confluence transaction to be read and interpreted in exactly the same way as root and non-root nodes, such that each parent node of a confluence can be discerned from its input script and the OP_RETURN reference(s).

The transaction shown in Table 4 is the simplest example of a Metanet confluence. It comprises two inputs from two parents A and B denoted by P_{parent,A} and P_{parent,B} respectively and two OP_RETURN parent transaction references TxID_{parent,A} and TxID_{parent,B}.

TABLE 4
A confluence node with two parents, created
using two Metanet-related inputs
TxID_{confluence}

| Inputs | Outputs |
|---|---|
| <Sig P_{parent, A}> | OP_RETURN <0x4d455441> |
| <P_{parent, A}> | <P_{confluence}> |
| <Sig P_{parent, B}> | <TxID_{parent, A}> |
| <P_{parent, B}> | <TxID_{parent, B}> |

The OP_RETURN output of a confluence transaction also establishes the permission to create a child of the confluence, namely that a child can only be created by the owner of the private key s_{confluence} corresponding to the public key P_{confluence}=s_{confluence}·G, where G is the elliptic curve base point.

It is therefore sensible to recommend that both parent signatures be appended with either of the signature flags SIGHASH_ALL or SIGHASH_ALL|ANYONECANPAY in the Bitcoin protocol or functionally similar/same mechanism in an alternative blockchain protocol. SIGHASH_ALL is a signature hash type which signs the entire transaction except any unlocking script, preventing modification of the signed parts. SIGHASH_ALL|ANYONECANPAY signs all of the outputs but only the one, specified input, and also allows anyone to add or remove other inputs. Use of SIGHASH_ALL will ensure that both parent public keys are always signing the OP_RETURN output and thus attesting and consenting to the newly defined permission to create children that is vested in P_{confluence} when a confluence transaction is created.

This is an important consideration to make when creating a confluence transaction as the parent public keys P_{parent,A} and P_{parent,B} could be controlled by different entities. In such a case, a confluence can therefore define the consolidation of authority or permission from two entities, using their own keys independently, into a single shared authority using a ‘shared’ key P_{confluence}.

This provides a significant improvement over the prior art in that it provides for a more versatile and more sophisticated cryptographic control mechanism. It also means that embodiments can be used to advantage to better reflect the technical (control, security and ownership) requirements of data creators, owners and users.

Whether or not this key is actually shared (e.g. by splitting) between multiple entities is an implementation choice that depends on a given embodiment. However, this consolidation of ‘key authority’ as a concept should be acknowledged, as Metanet confluence nodes inherit the permissioning structure set out in the core Metanet design

A more complex example of a confluence transaction is shown below in Table 5. This confluence has been generalised to include k parents, which means it has the requisite minimum of k inputs, each comprising a signature from a distinct parent node, as well as k references to respective parent transactions.

This confluence therefore represents the convergence of a total of k trees and/or branches.

TABLE 5
A confluence node with k parents, created
using k Metanet-related inputs
TxID_{confluence}

| Inputs | Outputs |
|---|---|
| <Sig P_{parent, A}> | OP_RETURN <0x4d455441> |
| <P_{parent, A}> | <P_{confluence}> |
| <Sig P_{parent, B}> | <TxID_{parent, A}> |
| <P_{parent, B}> | <TxID_{parent, B}> |
| . | . |
| . | . |
| . | . |
| <Sig P_{parent, k}> <P_{parent, k}> | <TxID_{parent, k}> |

In the above transaction diagram, we have expressed the simplest form of a k-parent confluence with exactly n=k inputs. However, as outlined above, it is also possible for such a confluence to have more inputs than parents.

The transaction diagram shown in Table 6 shows an example of a confluence transaction which has n>k inputs. Recall that, for the confluence to have k parents then it must necessarily have a minimum of k inputs to represent them, but that this does not preclude the existence of an additional n-k inputs that are not considered relevant to the Metanet perspective of a confluence.

TABLE 6
The confluence node of Table 5, showing a total of n inputs, where
only k < n are Metanet-related (table cells with single line borders)
and the remainder are not related to the Metanet (table cells with
double line borders).
TxID_{confluence}

| Inputs | Outputs |
|---|---|
| 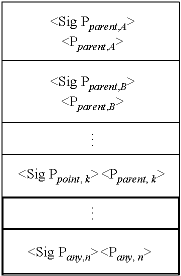 | OP_RETURN <0x4d455441> <P_{confluence}> <TxID_{parent,A}> <TxID_{parent,B}> . . . <TxID_{parent, k}> |

This confluence is structurally identical to the transaction shown in Table 5, the only difference being the additional inputs (shown in the two bottom left corner cells with double line borders). The remainder of the transaction (single line bordered cells) is effectively the same as in Table 5, noting only that the actual values (r, s) of the parent signatures will likely be different as the additional inputs have modified the transaction message that is signed. The single-line bordered portions of this transaction are what the Metanet protocol considers and reads when constructing a Metanet graph.

Confluence Use-Case Scenarios

The enhanced Metanet solutions provided in the present disclosure enable a greater number of data structures to be modelled and represented. For example, embodiments enable shared ownership or control of data to be modelled and implemented in manner that is not possible with existing solutions. A wider variety of authorisation and permission control techniques are now possible with the use of the disclosure, resulting in improved security of data and systems. Shared ownership/control of blockchain data, or attestation thereof, can be more easily be expressed with the use of multiple parents, than with structures where a single key is ‘shared’ between entities. The present disclosure enables an explicit way of signifying, enforcing and/or attesting to shared ownership/consent/permissions to a node, which could be useful or even essential in many applications.

Thus, embodiments provide a greater degree of flexibility and expressiveness compared to previous Metanet disclosures. More complex structures can be constructed, thus providing enhanced functionality in terms of the data storage, processing and retrieval systems that can be built from the more sophisticated hierarchies. By providing for more complex representations of the underlying data structures, the disclosure enables technical solutions to be built which are advantageous in terms of access control and efficiency in identifying and transmitting data.

The efficient, scalable and secure design of data storage and retrieval systems is not a trivial task. Numerous use-case scenarios may give rise to the need for a solution in accordance with the present disclosure. These include, but are not limited to, illustrative scenarios such as:
Multiple trees—where distinct metanet trees converge
An example of this is provided in FIG. 7, which depicts a scenario wherein two previously separate and distinct Metanet trees converge at a single confluence transaction in accordance with embodiments of the present disclosure; a single Metanet tree has a well-defined permissioning structure, governed by the hierarchy of public key addresses and signatures that create the edges between nodes.
an example situation may be when two entities e.g. businesses or other organisations need to merge their access permissions over a file system. Consider a scenario whereby two companies, whose assets are represented on-chain by distinct Metanet trees, undergo a corporate takeover/merger/conglomeration. Each company's tree could represent either a set of assets or the on-chain record of corporate structure. Two companies provide inputs from the end of their respective trees.
   Multiple branches—where distinct branches within a single Metanet tree converge This scenario arises when two branches existing within one tree are merged together;
   an example could be the merging of a file with some changes or a “commit” action in a GIT-like versioning system
   Combination of both the previous scenarios—where a combination of trees and branches converge
   This is a more complex scenario arising from a more complex operation, which results in merging both multiple tress and multiple branches into the same confluence. This may occur, for example, due to a more complex merger or versioning system. Scenarios may provide for the implementation of fully-fledged file systems that implement create, read, update, and delete (CRUD) operations, the definition of a transaction format or type for each CRUD operation; and use of the Metanet's versioning abilities.

Each of the above scenarios are encompassed by the Metanet Confluences concepts detailed above but may arise due to different uses cases or implementation requirements.

Enumerated Clauses

Embodiments of the present disclosure provide, at least: an arrangement that enables data to be stored, processed, retrieved, searched and/or transmitted between parties in a secure and improved manner on the blockchain, advantageously utilising the distributed, unalterable and permanent benefits of blockchain technology.

In accordance with embodiments of the disclosure there may be provided a computer implemented method and corresponding system(s). The method may be described as enabling or controlling the secure and communication, processing, storing, structuring, retrieving, identifying, authorisation and/or sharing of data via a blockchain. Additionally, or alternatively, it may be described as a method for associating or linking data stored within (separate/different) blockchain transactions to enable the identification, retrieval and/or sharing of said data. It also provides a security solution for securing access to the data, ensuring that only authorised parties are able to access it.

Embodiments of the present disclosure are provided in the following enumerated clauses for the purpose of illustration, and without limitation. Thus, there may be provided:

1. A (computer and/or blockchain implemented) method including the step of processing at least one blockchain transaction (Tx). The method may comprise a transaction ID (TxID) and:
at least one discretionary transaction ID (DTxID);
   a protocol flag;
   at least one discretionary public key (DPK); and
   a plurality of inputs, each input comprising:
      i) a parent public key (PPK) and
      ii) a signature (S) generated using the parent public key (PPK).

This combination of features enables portions of data (data items) to be stored, identified, logically associated, cryptographically secured and/or accessed on a blockchain. It also enables them to be linked/associated with one another when provided in a plurality of transactions contained within the blockchain. It enables a graph or tree-like hierarchical structure to be constructed, which reflects the relationships and associations between portions of data, facilitating their processing, searching, access, generation and sharing. It also facilitates who, and by whom, operations may be performed on a given data item. Herein, “sharing” may include providing to a node or user, sending, communicating, transmitting or providing access to the portion of data. The logically associated transactions may not be stored on the blockchain at contiguous block heights but they (and thus their associated data) can be identified and/or accessed easily and securely.

The plurality of inputs enables the transaction (which can be referred to herein as a “confluence” or “confluence node” or “data node”) to be associated with one or more further blockchains transactions. The one or more further transactions may be “metanet nodes” or “confluence nodes”. At least one of the one or more further transactions may comprise at least one discretionary transaction ID (DTxID); a protocol flag; at least one discretionary public key (DPK) and one or more inputs each having a parent public key and a signature generated using the parent public key. At least one or more of the further transactions may be referred to as a logical parent transaction (LPTx).

The transaction ID (TxID) is the identifier for the transaction as known in the art of blockchain protocols—each blockchain transaction has a unique ID as part of the underlying blockchain protocol. By contrast, the discretionary public key (DPK) and/or the discretionary transaction ID (DTxID) may be “discretionary” in that they are provided as part of the present invention rather than essential component(s) of the transaction as dictated by the protocol of the underlying blockchain. Put another way, they are not required in order for the transaction to be valid in accordance with the protocol of the underlying blockchain eg Bitcoin. Additionally or alternatively, they may be described as additional, non-essential items which are provided as part of the present invention, not because the blockchain protocol requires them.

Preferably, the protocol flag is associated with and/or indicative of a blockchain-based protocol for searching for, storing in and/or retrieving data in one or more blockchain transactions. The protocol flag may be an indicator or marker. It may indicate that the transaction is formed in accordance with a pre-determined protocol. This may be a protocol other than the protocol of the underlying blockchain. It may be a search protocol in accordance with any embodiment described herein (i.e. what may be referred to as the “metanet” protocol referred to herein).

The term “processing” may be interpreted as meaning any activity relating to the transaction and/or its associated data, including generating, transmitting, validating, accessing, searching for, sharing, submitting to a blockchain network, and/or identifying.

The discretionary transaction ID may be an identifier, label, indicator or tag which is associated with the transaction (Tx) in accordance with an embodiment of the present invention. We use the term “indicator” to include all of these terms. It should be noted that, as known in the art and readily understood by the skilled addressee, each transaction on a blockchain is uniquely identified by an identifier, typically referred to in the art as the TxID. The TxID is an essential, required and non-discretionary part of the underlying blockchain protocol. This non-discretionary TxID is not to be confused with the discretionary transaction ID (DTxID) as referred to herein.

A combination of the at least one discretionary public key and transaction ID may specify a unique identifier or index for the transaction (Tx), and may be hashed, such that ID_{Tx}=P_{Tx}∥TxID_{Tx}

The method may comprise the step of generating the Discretionary ID based on the Discretionary Public Key and the Transaction ID.

2. A method according to clause 1 wherein the transaction (Tx) further comprises a portion of data, or a reference to a portion of data. The reference to the portion of data may be a pointer, address or other indicator of a location where the data is stored. The portion of data may be any type of data or digital content e.g. a computer-executable item, text, video, images, sound file etc. The portion of data may be referred to as “content”. The portion of data or the reference to it may be in a processed form. For example, it may be a hash digest of the portion of data. The data may be stored on the blockchain or off it (i.e. “off chain”).

Preferably, the transaction (Tx) further comprises one or more attributes. This enables a more detailed approach to searching for data/content. The attributes may also be referred to as “values”, “labels” or “tags” or “identifiers”. They may be used to describe or annotate the portion of data, or provide additional information relating to the portion of data.

Preferably, the one or more attributes comprises a keyword, tag or identifier associated with:

i) a/the portion of data provided within or referenced within the transaction (Tx); and/or

ii) the transaction (Tx).

3. A method according to clause 1 or 2 wherein the portion of data or reference to the portion of data, the protocol flag, the at least one discretionary public key (DPK) and/or the at least one discretionary transaction ID (DTxID) are provided within an output (UTXO) of the blockchain transaction (Tx). One or more of them may be provided within a locking script associated with the output (UTXO).

4. A method according to any of clauses 1 to 3 wherein:

each parent public key (PPK) in the plurality of inputs is associated with a respective logical parent transaction (LPTx) that is identified by a respective discretionary transaction ID (DTxID) provided in an output (UTXO) of the transaction (Tx).

5. A method according to clause 4 wherein the blockchain transaction (Tx) is arranged such that:

i) at least two of the parent public keys (PPKs) of the plurality of inputs are required to sign the output (UTXO) of the transaction (Tx); or

ii) all of the parent public keys (PPKs) of the plurality of inputs are required to sign the output (UTXO) of the transaction (Tx).

6. A method according to any of clauses 1 to 5 wherein:

the portion of data, reference to the portion of data, the protocol flag, the at least one discretionary public key (DPK) and/or the at least one discretionary transaction ID (DTxID) are provided within the blockchain transaction (Tx) at a location following a marker or code for marking an output as invalid for subsequent use as an input to a subsequent transaction. This may be a script opcode. It may be the OP_RETURN opcode in one or more variants of the Bitcoin protocol, or may be a functionally similar/equivalent opcode from another blockchain protocol.

7. A method according to any of clauses 1 to 6, and further comprising the step of: using the discretionary public key (DPK) and the transaction ID (TxID) to search for and/or identify the transaction (Tx) or the logical parent transaction within a blockchain.

8. A method according to clause 7 and further comprising the step of:

using the blockchain transaction (Tx) to represent a data node in a hierarchy, tree or graph of data nodes. A data node may be described as a transaction which represents a node in a tree, graph or hierarchy and contains or references a portion of data in a data set.

9. A method according to any of clauses 1 to 8 wherein the protocol flag is associated with and/or indicative of a blockchain-based protocol for searching for, storing in and/or retrieving data in one or more blockchain transactions.

10 A method according to any of clauses 1 to 9 and comprising the step of processing at least one further blockchain transaction (Tx2) comprising a further transaction ID (TxID2) and:
at least one further discretionary transaction ID (DTxID);
   a protocol flag;
   at least one further discretionary public key (DPK); and
   one or more inputs, each input comprising:
      i) a parent public key (PPK) and
      ii) a signature (S) generated using the parent public key (PPK).

In other words, a plurality of transactions may be provided which, as described above, for a hierarchy or tree-like structure.

11. A method according to clause 10 wherein the at least one transaction (Tx) and the at least one further transaction (Tx2) are arranged to form a hierarchy of blockchain transactions, and such that a portion of data provided in or referenced in the at least one further transaction (Tx2) in a lower level of the hierarchy can be accessed or identified by comparison with a cryptographic key used to sign the at least one transaction in a higher level of the hierarchy.

12. A blockchain-implemented network or system comprising a plurality of computing nodes, wherein each computing node in the blockchain-implemented network or system comprises:
a processor; and
memory including executable instructions that, as a result of execution by the processor, causes the system or network to perform the computer-implemented method of any preceding clause.

13. A network or system according to clause 12 and further comprising:
at least one wallet function, preferably wherein the wallet function is arranged to store,
generate and/or process hierarchical deterministic keys.

The network may be arranged to operate using and/or interface with a blockchain protocol.

14. A non-transitory computer-readable storage medium having stored thereon executable instructions that, as a result of being executed by a processor of a computer system, cause the computer system to perform the computer-implemented method of any one of clauses 1 to 11.

In accordance with the disclosure, a method may be provided including the step of providing or using a plurality of blockchain transactions in a (logical) hierarchy such that a portion of data provided or referenced in at least one further transaction in a lower level of the hierarchy can be accessed or identified by comparison with a cryptographic key used to sign a first transaction in a higher level of the hierarchy; wherein:

at least one transaction in the hierarchy (the first or a further transaction) comprises

a transaction ID (TxID); a protocol flag; a discretionary public key (DPK); a discretionary transaction ID (DTxID) and a plurality of inputs, each input comprising:
i) a parent public key (PPK) and
ii) a signature (S) generated using the parent public key (PPK).

Additionally, or alternatively, the method may comprise: using a first blockchain transaction to provide or prohibit access to a portion of data provided or referenced in at least one further transaction in a lower level in a hierarchy of blockchain transactions based on a cryptographic key used to sign the first blockchain transaction. The first and/or a further transaction may comprise: a transaction ID (TxID); a protocol flag; a discretionary public key (DPK); a discretionary transaction ID (DTxID); and a plurality of inputs, each input comprising: i) a parent public key (PPK) and ii) a signature (S) generated using the parent public key (PPK).

In accordance with another aspect of the disclosure, there may be provided a computer implemented system for searching a blockchain and/or identifying/accessing data via a blockchain. It may be described as a blockchain search system.

Enumerated clauses are provided as follows:

A) A computer-implemented system arranged to enable a user (human or computer-implemented resource) to search for, access, view, write and/or retrieve a portion of data provided in at least one blockchain transaction (Tx), wherein:

the system is arranged to identify the at least one transaction (Tx) based on a transaction index (TX_{index}) comprising a transaction ID and a public key associated with the transaction (Tx). The at least one transaction may comprise:
at least one output (UTXO) comprising
   at least one discretionary transaction ID (DTxID);
   a protocol flag; and
   at least one discretionary public key (DPK);
and
   one or more inputs, each comprising:
      i) a parent public key (PPK) and
      ii) a signature (S) generated using the parent public key (PPK).

Thus, in one or more embodiments the at least transaction comprises a plurality of inputs, each having a parent public key and a signature generated using the parent public key.

B. A system according to clause A wherein the system comprises a search facility which is: provided within the computer-implemented (blockchain search) system; or arranged to interface and/or communicate with the blockchain search system.

C. A system according to clause A or B, and further comprising at least one wallet function.

D. A system according to clause C wherein the at least one wallet is arranged to generate, store and/or process hierarchical deterministic keys.

E. A system according to clause C or D wherein the at least one wallet function is arranged to store at least one cryptographic key and/or at least one token in a Trusted Execution Environment.

F. A system according to any of clauses A to E, and further comprising:

a decompression component arranged to decompress the portion of data if it is compressed;

a recombination component;

and/or

a decryption component arranged to decrypt the portion of data if it is encrypted.

G. A system according to any of clauses A to F, and further comprising:
at least one presentation component arranged to present the portion of data to a user in an audible and/or visual form.

H. A system according to any of clauses A to G, and further comprising:
means for inputting or generating a search path to identify the at least one transaction (Tx) on the blockchain, the search path comprising:
   i) the transaction index (TX_{index}); and
   ii) at least one attribute associated with the transaction (Tx).

I. A system according to clause H wherein: at least one of the attributes is a mnemonic associated with the transaction; and/or the at least one attribute is null.

J. A system according to of any of clauses A to I, and further arranged to: communicate with a wallet function or other resource to facilitate processing, storage and/or generation of cryptographic keys, blockchain transactions and/or digital signatures.

K. A system according to any of clauses A to J, and further arranged to: store the transaction index (TX_{index}), preferably wherein the system is arranged to store respective transaction indices for more than one transaction.

L. A system according to any of clauses A to K, and further arranged to: transfer control of a portion of a digital asset to a destination prior to accessing the portion of data.

M. A system according to any of clauses A to L, and further arranged to send a request, to a peer on the blockchain, for the portion of data; and/or receive the portion of data from a peer on the blockchain

N. A system according to any of clauses A to M wherein the system is further arranged to: use a time lock mechanism to control access to the portion of data.

Example System Overview

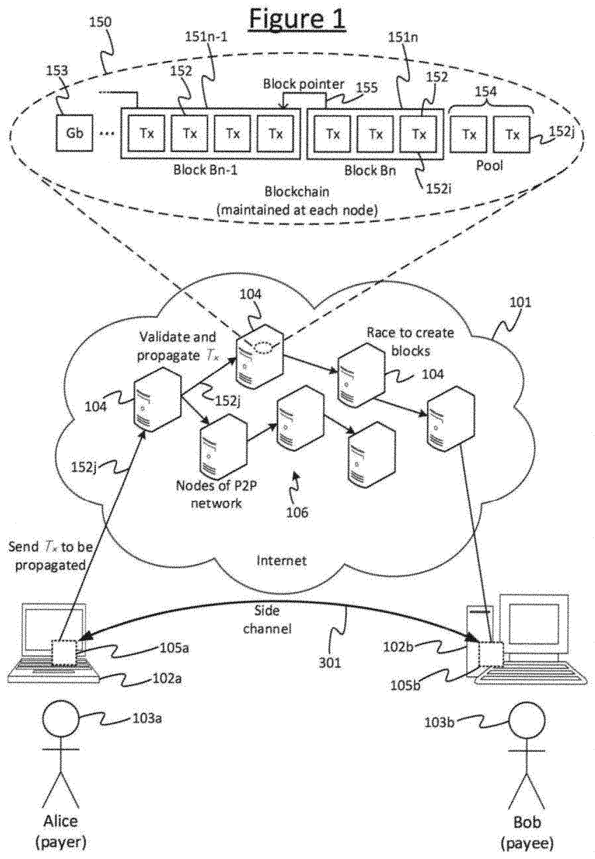

FIG. 1 shows an example system 100 for implementing a blockchain 150. The system 100 may comprise of a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as Application Specific Integrated Circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 160. As mentioned above, maintaining a copy of the blockchain 150 does not necessarily mean storing the blockchain 150 in full. Instead, the blockchain 150 may be pruned of data so long as each blockchain node 150 stores the blockheader (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set 154 of transactions 152 waiting to be incorporated into blocks 151. The ordered set 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when an entity, such as a user or machine, 103 wishes to enact a new transaction 152j, then the entity sends the new transaction from its computer terminal 102 to a recipient. The entity or the recipient will eventually send this transaction to one or more of the blockchain nodes 104 of the network 106 (which nowadays are typically servers or data centres, but could in principle be other user terminals). It is also not excluded that the entity 103 enacting the new transaction 152j could send the transaction to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the entity 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned is whether it has yet been validly redeemed by the input of another, onward transaction 152j according to the blockchain node protocol. Another condition for a transaction to be valid is that the output of the preceding transaction 152i which it attempts to assign or redeem has not already been assigned/redeemed by another transaction. Again, if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered set 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically, this comprises searching for a “nonce” value such that when the nonce is concatenated with a representation of the ordered set of transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. A significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the ordered set of yet to be published transactions 154 at any given time, depending on when they started searching for a solution or the order in which the transactions were received. Whoever solves their respective puzzle first defines which transactions 152 are included in the next new block 151n and in which order, and the current set 154 of unpublished transactions is updated. The blockchain nodes 104 then continue to race to create a block from the newly defined outstanding ordered set of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to assign an accepted amount of the digital asset in a new special kind of transaction which distributes a defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “mining fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network but do not participate in validating, constructing or propagating transactions and blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered set of transactions 154 maintained at a given blockchain node 104, that blockchain node 104 will start competing to solve the proof-of-work puzzle on the latest version of their respective ordered set of transactions 154 including the new transaction 152 (recall that other blockchain nodes 104 may be trying to solve the puzzle based on a different ordered set of transactions 154, but whoever gets there first will define the ordered set of transactions that are included in the latest block 151. Eventually a blockchain node 104 will solve the puzzle for a part of the ordered set 154 which includes Alice's transaction 152j). Once the proof-of-work has been done for the ordered set 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

UTXO-Based Model

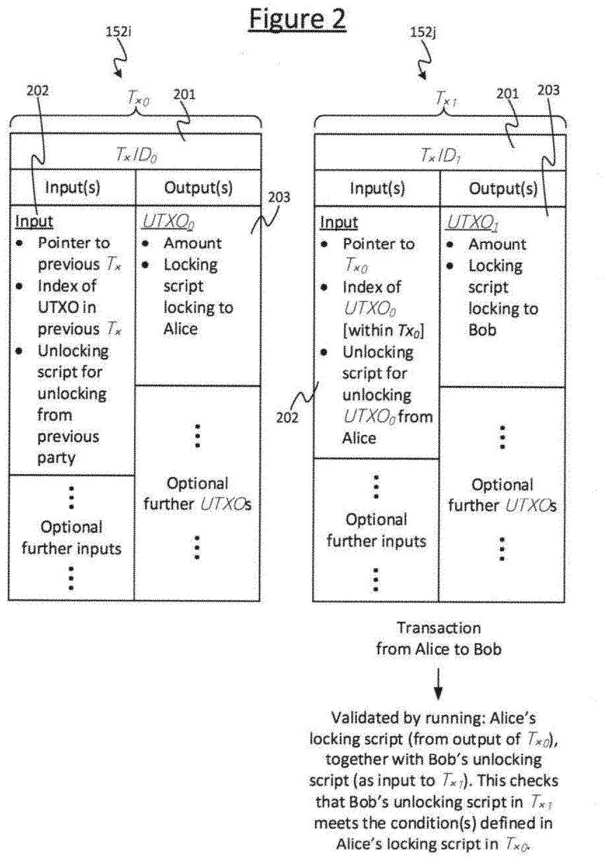

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions.

The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥[Checksig P_{A}]

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered set of transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node that publishes her transaction 104. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that publishes the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

As shown in FIG. 1, the client application on each of Alice and Bob's computer equipment 102a, 120b, respectively, may comprise additional communication functionality. This additional functionality enables Alice 103a to establish a separate side channel 301 with Bob 103b (at the instigation of either party or a third party). The side channel 301 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 301 may be used to exchange any other transaction related data, such as keys, negotiated amounts or terms, data content, etc.

The side channel 301 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 301 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 301. Note therefore that if it is said that Alice and Bob exchange certain pieces of information or data, or such like, over the side channel 301, then this does not necessarily imply all these pieces of data have to be send over exactly the same link or even the same type of network.

Client Software

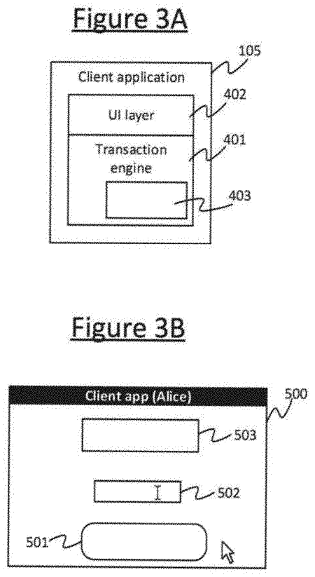

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly. In accordance with embodiments disclosed herein, the transaction engine 401 of each client 105 comprises a function 403 . . . .

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer.

Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands). The options enable the user (Alice) to . . . .

Alternatively or additionally, the UI elements may comprise one or more data entry fields 502, through which the user can . . . . These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

Node Software

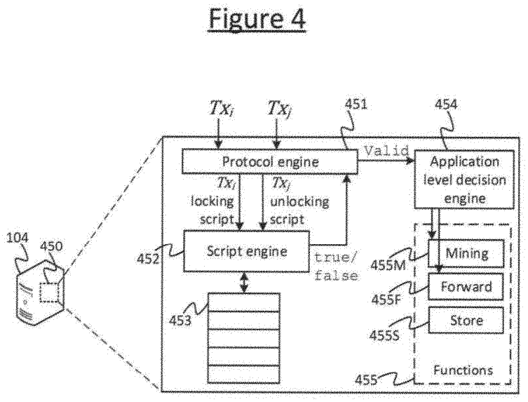

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txⱼ from the ordered set 154 of unpublished transactions maintained by the node 104. Either way, the script engine 451 identifies the locking script in the referenced output of Txⱼ and passes this to the script engine 452.

The script engine 452 thus has the locking script of Txⱼ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance, in an account-based model, a result of “true” could be indicated by a combination of an implicit, protocol-level validation of a signature and an additional affirmative output of a smart contract (the overall result being deemed to signal true if both individual outcomes are true).

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However, it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In non-preferred embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

1. A computer implemented method including the step of processing at least one blockchain transaction (Tx) comprising a transaction ID (TxID) and:
at least one discretionary transaction ID (DTxID);
a protocol flag;
at least one discretionary public key (DPK); and
a plurality of inputs, each input comprising:
i) a parent public key (PPK) and
ii) a signature (S) generated using the parent public key (PPK).

2. The method according to claim 1, wherein the transaction (Tx) further comprises:
a portion of data, or a reference to a portion of data.

3. The method according to claim 2 wherein the portion of data or reference to the portion of data, the protocol flag, the at least one discretionary public key (DPK) and/or the at least one discretionary transaction ID (DTxID) are provided within an output (UTXO) of the blockchain transaction (Tx);
preferably within a locking script associated with the output (UTXO).

4. The method according to claim 1, wherein:
each parent public key (PPK) in the plurality of inputs is associated with a respective logical parent transaction (LPTx) that is identified by a respective discretionary transaction ID (DTxID) provided in an output (UTXO) of the transaction (Tx).

5. The method according to claim 4, wherein the blockchain transaction (Tx) is arranged such that:
i) at least two of the parent public keys (PPKs) of the plurality of inputs are required to sign the output (UTXO) of the transaction (Tx); or
ii) all of the parent public keys (PPKs) of the plurality of inputs are required to sign the output (UTXO) of the transaction (Tx).

6. The method according to claim 2, wherein:
the portion of data, reference to the portion of data, the protocol flag, the at least one discretionary public key (DPK) and/or the at least one discretionary transaction ID (DTxID) are provided within the blockchain transaction (Tx) at a location following a marker or code for marking an output as invalid for subsequent use as an input to a subsequent transaction.

7. The method according to claim 1, further comprising the step of:
using the discretionary public key (DPK) and the transaction ID (TxID) to search for and/or identify the transaction (Tx) or a logical parent transaction within a blockchain.

8. The method according to claim 1, further comprising the step of:
using the blockchain transaction (Tx) to represent a data node in a hierarchy, tree or graph of data nodes.

9. The method according to claim 1, wherein the protocol flag is associated with and/or indicative of a blockchain-based protocol for searching for, storing in and/or retrieving data in one or more blockchain transactions.

10. The method according to claim 1, further comprising the step of processing at least one further blockchain transaction (Tx2) comprising a further transaction ID (TxID2) and:
at least one further discretionary transaction ID (DTxID);
a protocol flag;
at least one further discretionary public key (DPK); and
a plurality of inputs, each input comprising:
i) a parent public key (PPK) and
ii) a signature (S) generated using the parent public key (PPK).

11. The method according to claim 10, wherein the at least one transaction (Tx) and the at least one further transaction (Tx2) are arranged to form a hierarchy of blockchain transactions, and such that a portion of data provided in or referenced in the at least one further transaction (Tx2) in a lower level of the hierarchy can be accessed or identified by comparison with a cryptographic key used to sign the at least one transaction in a higher level of the hierarchy.

12-13. (canceled)

14. A computer-implemented system arranged to enable a user to search for, access, view, write and/or retrieve a portion of data provided in at least one blockchain transaction (Tx), wherein:
the system is arranged to identify the at least one transaction (Tx) based on a transaction index (TX_{index}) comprising a transaction ID and a public key associated with the transaction (Tx); and the at least one transaction comprises:
at least one output (UTXO) comprising
at least one discretionary transaction ID (DTxID);
a protocol flag; and
at least one discretionary public key (DPK);
and
a plurality of inputs, each comprising:
i) a parent public key (PPK) and
ii) a signature (S) generated using the parent public key (PPK).

15-16. (canceled)

17. A non-transitory computer-readable storage medium having stored thereon executable instructions that, as a result of being executed by a processor of a computer system, cause the computer system to perform a computer-implemented method of processing at least one blockchain transaction (Tx) comprising a transaction ID (TxID) and:
at least one discretionary transaction ID (DTxID);
a protocol flag;
at least one discretionary public key (DPK); and
a plurality of inputs, each input comprising:
i) a parent public key (PPK) and
ii) a signature (S) generated using the parent public key (PPK).
